(19) United States
(12) Patent Application Publication
(10) Pub. No.: US 2025/0179384 A1
(43) Pub. Date: Jun. 5, 2025

(54) FIRE STARTER AND PREPARATION METHODS THEREFOR

(71) Applicant: Michal Kehati, Moshav Mattah (IL)

(72) Inventor: Michal Kehati, Moshav Mattah (IL)

(21) Appl. No.: 18/918,702

(22) Filed: Oct. 17, 2024

Related U.S. Application Data
(63) Continuation of application No. PCT/IL2023/050399, filed on Apr. 17, 2023.
(60) Provisional application No. 63/448,248, filed on Feb. 25, 2023.
(60) Provisional application No. 63/331,892, filed on Apr. 18, 2022.

(51) Int. Cl. C10L 5/44

(52) U.S. Cl. CPC C10L 5/445; C10L 2200/0484; C10L 2230/06; C10L 2230/10

(57) ABSTRACT

The present invention provides an improved fire starter that includes inter alia citrus peels processed in a unique form to enable fast, “green” and smooth charcoal lighting and methods of preparation therefor.

### FIELD OF THE INVENTION

The present invention relates to “green” and safe-to-use fire starter for the commencement of the burning of charcoal or wood for use primarily in barbecue cooking devices, fire places, ovens and the like.

### BACKGROUND OF THE INVENTION

There are known in the market charcoal lighter liquids, such as kerosene and alcohols, which are flammable solvents used to accelerate lighting of charcoal in barbecue grills, ovens or fire places. However, the use of such solvents is disadvantageous in that these solvents are flammable and toxic by inhalation and may insert an unpleasant odor to the burned charcoal even after incineration.

Also available in the market are grates with an inverted cavity used to support fine particulate fuels such as sawdust. The fuel is usually lit from above, and the grate aids combustion by distributing air to a greater volume of the fuel since fine particulate fuel has a certain resistance to the flow of air. Such grates are not designed to employ combustion from below, but rather functions as the air delivery and distribution means provided by the natural cavities created by non-particulate fuels such as charcoal briquettes. The use of sawdust is not advantageous because breathing dust is not particularly healthy.

U.S. Pat. No. 4,257,391 recites a device designed to aid combustion of particulate fuel in a furnace so as to preclude the necessity and expense of forming briquettes from sawdust and the like. However, the speed of heating using charcoal briquettes is usually slow.

Thus, there are available in the market grate designs aimed at increasing the efficiency of steady state combustion of various fuels within their respective fire boxes but the rate at which the combustion is started can be slow.

Attempts have been made to speed up the heating of several briquettes, as recited e.g., in U.S. Pat. Nos. 4,417,565 and 4,896,650 by altering the device's cavity being incorporated into the grate or by decreasing the heating time of chimney style charcoal starters using a Venturi effect. However, the Venturi effect will only play a major role during the initial kindling combustion phase, and will largely disappear during the much longer charcoal heating phase.

Also available are briquettes that self-radiate allowing for nearly unrestricted convection. Effectively, the briquettes are assembled in such a way as to form a miniature cavity, open at top and bottom, and one briquette is located at high point. However, this assembly does not solve the problem of lighting a substantial quantity of briquettes for later disposition in a barbecue, as does a chimney style charcoal starter.

Thus, there is a need in the market for a non-briquette and improved “green” fire starter that allows the charcoal or wood to catch fire swiftly in significantly less time and without leaving an unpleasant odor. The present invention provides such a fire starter along with methods of producing same.

### BRIEF SUMMARY OF THE INVENTION

The present invention discloses an improved and “green” fire starter for lighting outdoor grill devices, BBQs, fireplaces or ovens comprising a dried mass of citrus peels to which an organic wick is connected, dipped in a natural resin or in essential oil, aroma chemical or fragrance and/or covered with a natural oil, natural resin or gum and optionally wrapped with paper.

According to the present invention, said improved and “green” outdoor grill device, BBQ, fireplace or oven fire starter enables fast and efficient lightning of charcoal or wood and can therefore be used, inter alia, for the commencement of the burning of charcoal or wood for use in barbecue cooking devices, fire places, ovens and the like.

According to some embodiments of the present invention, the citrus peels are selected from citron, grapefruit, lemon, lime, mandarin, orange, pomelo, sweet or bitter orange and the like and combination of citrus peels thereof.

Examples 19-23 of the present invention demonstrate control experiments that have been carried out showing that commercial fire starters such as briquette or fuel-based charcoal fire starter leave an unpleasant odor and/or liberate smoke and/or insert a non-natural taste to the meat.

According to an embodiment of the present invention, there is provided a method of producing said dried mass of citrus peels, comprising the following steps:
collecting peels of citrus fruits;
air-drying the peels and optionally further drying the peels in an oven;
adding an organic wick or thread;
optionally covering the peels with paper to form a package; and
covering the peels with a natural resin or wax that has been heated to liquid state.

According to an embodiment of the present invention, there is provided another method of producing said dried mass of citrus peels, comprising the following steps:
collecting peels of citrus fruits;
air-drying the peels and optionally further drying the peels in an oven;
adding an organic wick;
covering the peels with a natural oil, a natural resin or gum and/or an essential oil, aroma chemical or fragrance;
optionally covering the peels with paper; and
forming a package in any shape or form or leaving the peels in bulk form.

### BRIEF DESCRIPTION OF THE FIGURES

FIG. 1 depicts a photograph of the charcoal starter of example 1.

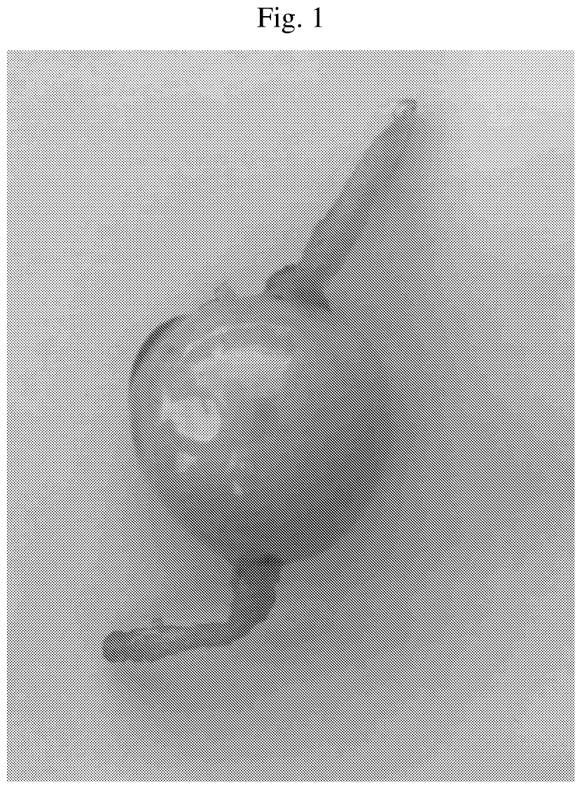

FIG. 2 depicts a photograph of the charcoal starter of example 1 lighting the fire in the BBQ.

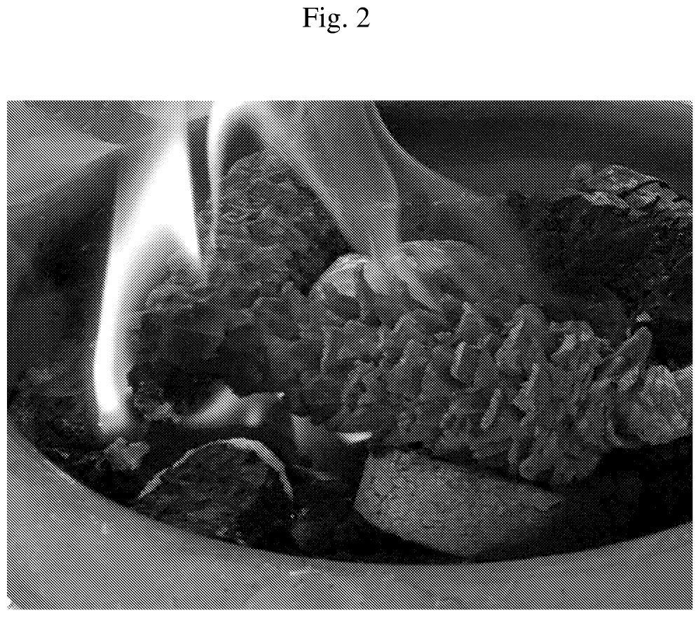

FIG. 3 depicts a photograph of citrus peels wrapped with colored paper before dipping in liquid resin

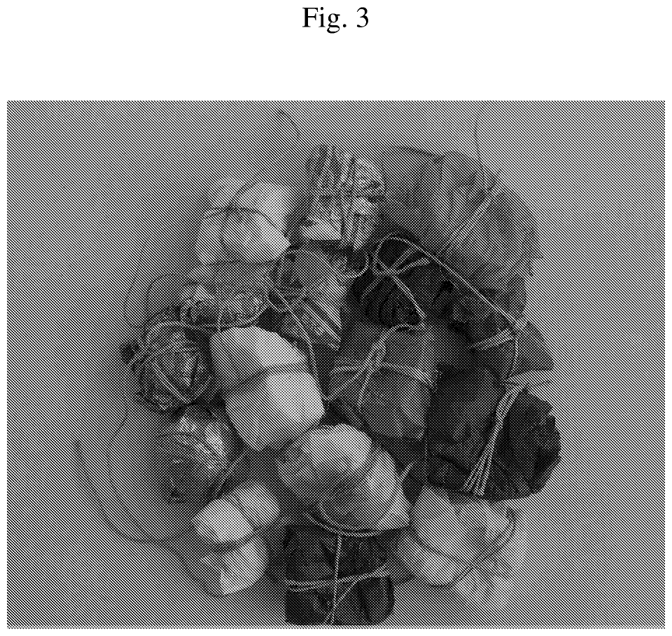

FIG. 4 depicts a photograph of citrus peels wrapped with white paper or printed paper before dipping in liquid resin.

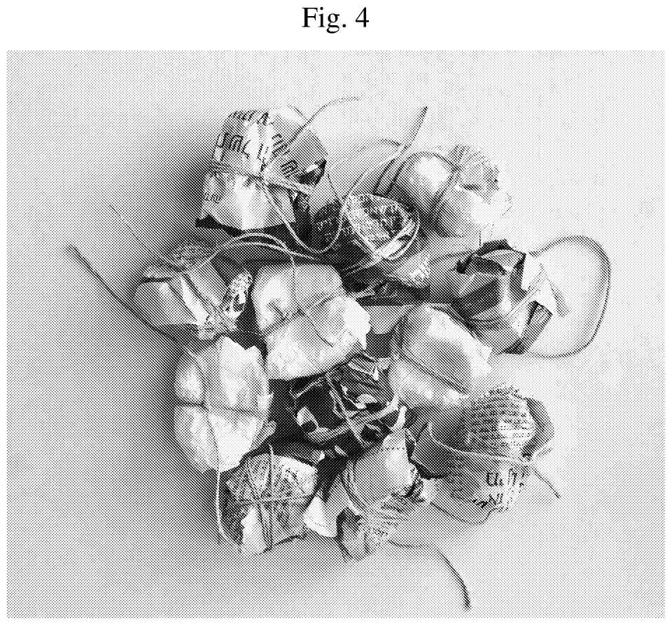

FIG. 5 depicts a photograph of lemon peels wrapped with white paper, dipped in resin and comprising a connected thread.

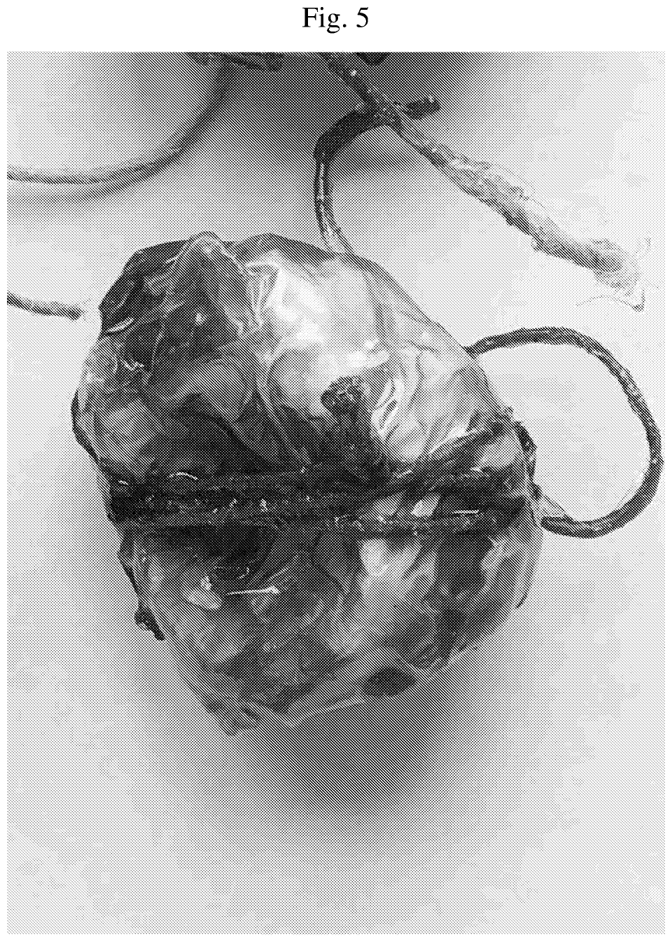

FIG. 6 depicts a photograph of the fire starter “candies”.

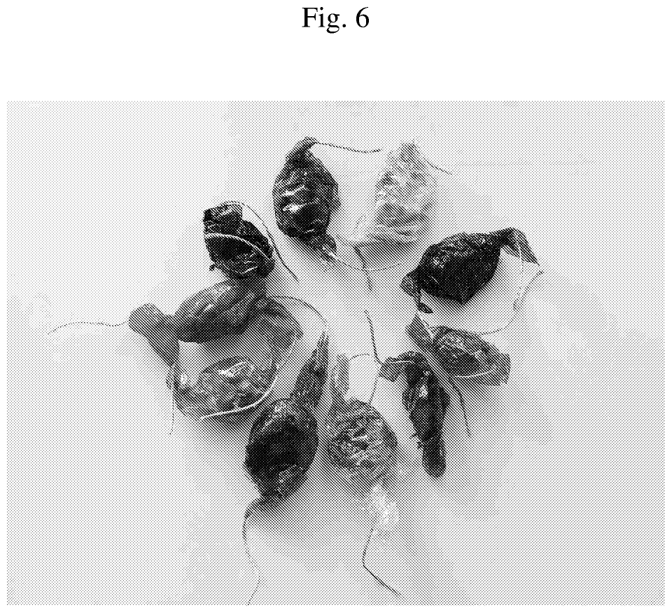

FIG. 7 depicts a photograph of wood lighted in the stove with the fire starter of the present invention.

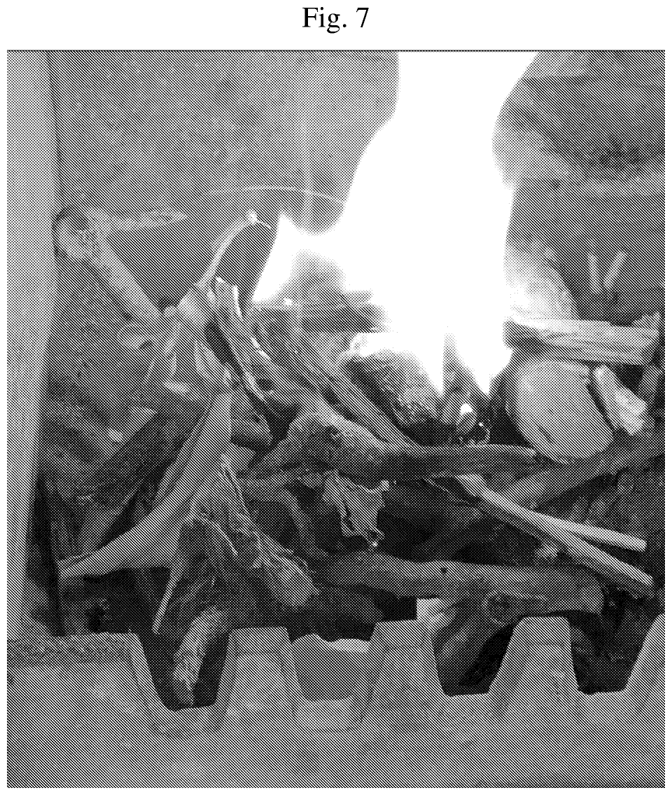

FIG. 8 depicts a photograph of an outside look of the fire started in the fireplace.

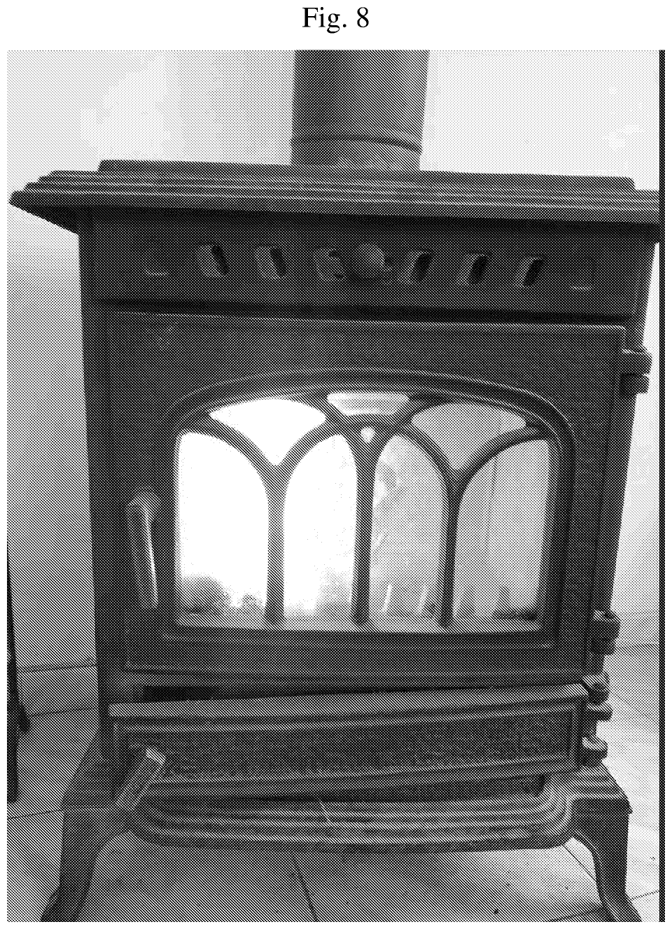

FIG. 9 depicts a photograph of citrus peels wrapped with paper and covered with resin.

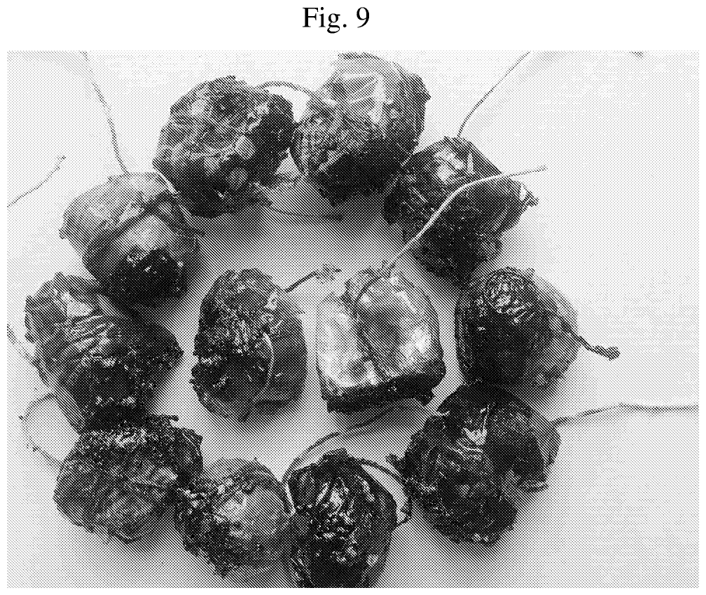

FIG. 10 depicts a photograph of lighting the charcoal with the fire starter of the present invention in the BBQ device

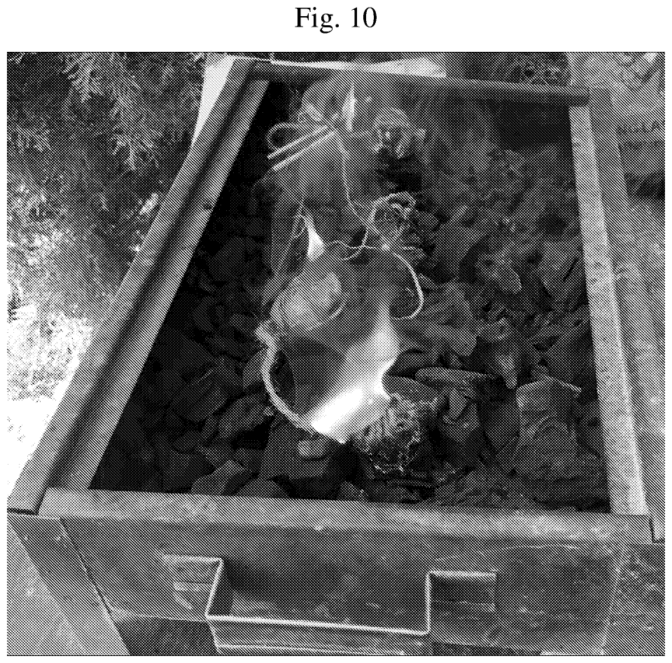

FIG. 11 depicts a photograph of the meat on the BBQ device as per Example 5.

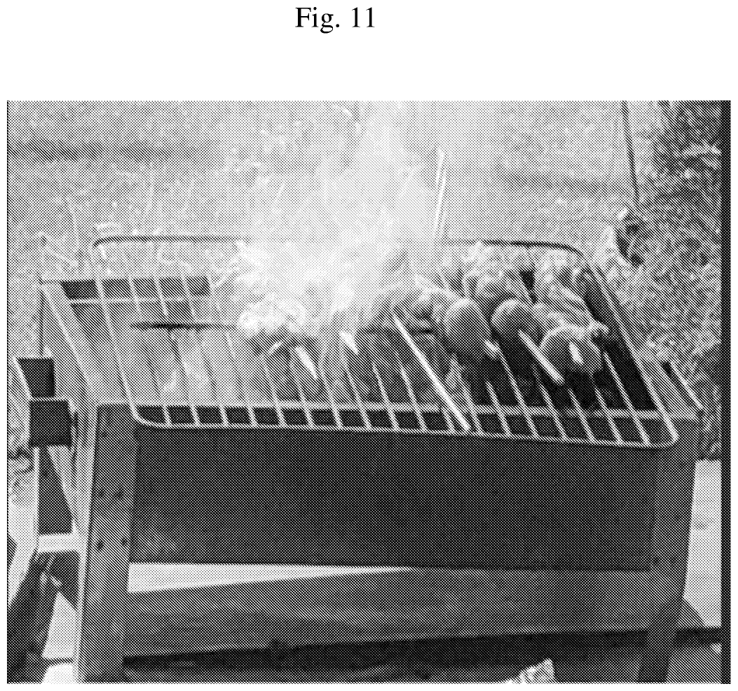

FIG. 12 depicts a photograph of the fire starter of the present invention in the BBQ device before lighting.

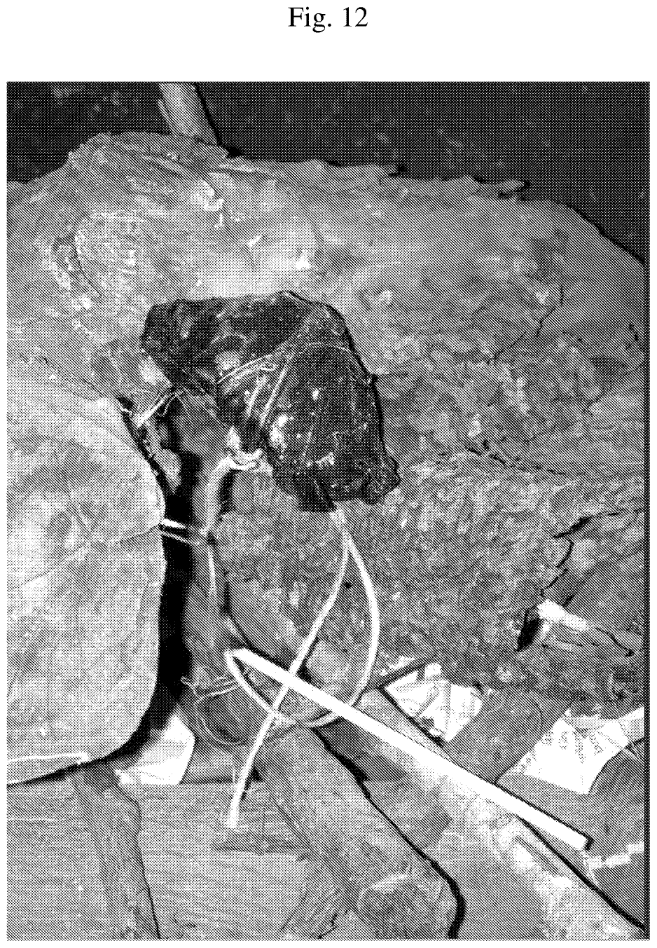

### DETAILED DESCRIPTION OF THE INVENTION

The present invention discloses an improved and “green” fire starter for lighting outdoor grill devices, BBQs, fireplaces or ovens comprising a dried mass of citrus peels to which an organic wick is connected, dipped in a natural resin or in essential oil, aroma chemical or fragrance and/or covered with a natural oil, natural resin or gum and optionally wrapped also with paper.

According to the present invention, said improved and “green” outdoor grill device, BBQ, fireplace or oven fire starter enables fast and efficient lightning of charcoal or wood and can therefore be used, inter alia, for the commencement of the burning of charcoal or wood for use in barbecue cooking devices, fire places, ovens and the like.

According to some embodiments of the present invention, the citrus peels are selected from citron, grapefruit, lemon, lime, mandarin, orange, pomelo, sweet or bitter orange and the like and combination of citrus peels thereof.

According to some embodiments of the present invention, the essential oils, aroma chemicals or fragrances are selected from Agar oil, Ajwain oil, Angelica root oil, Anise oil, Basil oil, Bay oil, Bergamot oil, Black pepper oil, Birch oil, Camphor oil, Caraway seed oil, Cardamom seed oil, Carrot seed oil, Carvacrol, Cedar oil, Chamomile oil, Cinnamon oil, Citron oil, Citronella oil, Clove oil, Coconut oil, Coriander oil, Cranberry seed oil, Cumin seed oil, Curry leaf oil, Cypress oil, Cypriol oil, Dill oil, Eucalyptus oil, Fennel seed oil, Garlic oil, Geranium oil, Ginger oil, Grapefruit oil, Henna oil, Horseradish oil, Jasmine oil, Lavender oil, Lemon oil, Lemongrass oil, Lime oil, Linalool, d-Limonene, Mandarin oil, Marjoram oil, Mint oil, Moringa oil, Mustard oil, Myrrh oil, Neem oil, Nutmeg oil, Orange oil, Oregano oil, Parsley oil, Perilla oil, Peppermint oil, Pine oil, Red Cedar oil, Rose oil, Rosemary oil, Rosewood oil, Sage oil, Savory oil, Spearmint oil, Tangerine oil, Tarragon oil, Tea tree oil, Thyme oil, Thymol, Turmeric and the like and combinations thereof.

According to an embodiment of the present invention, the use of essential oils, aroma chemicals or fragrances adds natural fruity aroma to the taste of the cooked meat while fuel-based fire starters may insert to the meat an unpleasant odor or taste.

According to experiments carried out by the inventor of the present invention it was uncovered that the commercial fire starters that have been tested such as fuel-based charcoal starters including kerosene inserted an unpleasant odor and taste to the meat or liberated a smoke having unpleasant odor.

Examples 19-23 of the present invention demonstrate control experiments that have been carried out showing that commercial fire starters such as fuel-based fire starters including kerosene leave an unpleasant odor and/or liberate smoke and/or insert a non-natural taste to the meat.

According to an embodiment of the present invention, the use of said organic, “green” and natural fire starter is safe in comparison to fuel-based fire starters such as kerosene, which may contain toxic and carcinogenic compounds such as benzene.

According to the present invention, the use of said organic, “green” and natural charcoal starter is safe in that it cannot leak and cause burns, which may occur while using fuel-based fire starters such as kerosene and alcohols.

According to the present invention, contrary to the use of petroleum-based fire starters such as kerosene, the use of said organic, “green” and natural fire starter reduces the emission of CO₂ because no hydrocarbons are burned to start the fire and also reduces the risk of causing photochemical smog through the evaporation of volatile organic compounds.

According to the present invention, the citrus peels are leftovers obtainable from the beverage processing industry while solvents such as kerosine and alcohols are produced from, e.g., crude oil, hence said citrus peels are cheep and “green” raw material in comparison to solvents such as kerosine and alcohols.

Thus, the improved natural, organic and “green” BBQ, fireplace or oven fire starter comprising dried mass of citrus peels of the present invention has an ecological advantage in comparison to solvents that can pollute the environment.

There are known in the market several charcoal lighter hydrocarbon mixtures such as naphtha or petroleum-based solvents, e.g., mineral spirits, containing N-alkanes, isoalkanes, cyclic alkanes and aromatics such as benzene. Also known in the market are alcohol-based solvents, which are usually methanol or ethanol. The solvents can be used both with lump charcoal and briquettes. The use of lighter charcoal solvents is disadvantageous as these solvents are combustible, harmful or fatal if swallowed, and may impart an unpleasant flavor to food cooked upon fires lit with it.

Moreover, petroleum-based charcoal lighter liquids may cause photochemical smog through evaporation of their volatile organic compounds.

Alcohol-based lighter solvents include methanol, which is toxic by inhalation, as detailed in Table 1b. Ethanol-based solvent is problematic due to the fact that sometimes it is consumed as a surrogate alcohol among very poor alcoholics because of its cheap price compared to vodka, especially in former Soviet countries.

Thus, Tables 1a and 1b below emphasize the advantages of the fire starter of the present invention in comparison to solvent fire starters such as kerosene and methanol respectively.

TABLE 1a

| | | The fire starter of the |
|---|---|---|
| Characteristic | Kerosene * | present invention |
| Content of components | Kerosine may contain | None |
| that may present health | derivatives of benzene and | |
| hazard | naphthalene | |
| Ecological advantage | None | Ecological product based on |
| | | natural ingredients |
| Manufacturing process | Produced from crude oil by | Based on leftovers from the |
| | distillation | beverage processing industry |
| Nature of the fire starter | Synthetic, it is a mixture of | Natural, “green” and organic |
| | petroleum hydrocarbons | |
| Odor | Disagreeable | Pleasant |
| Safety | May cause burns | Safe for use |
| Speed of lightning | Fast but flame can be | Fast |
| | extinguished spontaneously, | |
| | see example 23 | |
| Toxicity | Toxic by inhalation and skin | Non-toxic and safe |
| | irritant | |

* See the Merck Index, 12^{th} Edition, No. 5305

TABLE 1b

| | | The fire starter of the |
|---|---|---|
| covered | Methanol * | present invention |
| Content of components | Methanol is poisonous | None |
| that may present health | | |
| hazard | | |
| Ecological advantage | None | Ecological product based on |
| | | natural ingredients |
| Manufacturing process | Produced, inter alia, by | Based on leftovers from the |
| | reacting carbon monoxide | beverage processing industry |
| | (CO) and hydrogen | |
| Nature of the fire starter | Synthetic | Natural, “green” and organic |
| Odor | Slight alcoholic odor | Pleasant |
| Safety | May cause burns | Safe for use |
| Speed of lightning | Fast | Fast |
| Toxicity | Poisoning may occur from | Non-toxic and safe |
| | ingestion, inhalation or | |
| | percutaneous ingestion | |

* See the Merck Index, 12^{th} Edition, No. 6024

The improved and “green” BBQ, fireplace or oven fire starter of the present invention includes a natural wick or thread that enables simple and fast lighting of the charcoal or wood.

According to some embodiments of the present invention, the wicks or threads are selected from candle wicks, cotton wicks, hemp wicks, wood wicks and the like.

According to some embodiments of the present invention, said improved and “green” charcoal fire starter uses a cheap raw material and thus it is economical enabling lighting of fire with the use of small amount of said fire starter.

According to some embodiments of the present invention, the natural resins are selected from Amber, Balm of Gilead, Balsam, Boswellia, Colophonium, Copal, Dammar Gum, Elemi, Galbanum, Gum Guaiacum, Kauri Gum, Labdanum, Mastic, Myrrh, Olibanum, Sandarac Resin, Styrax and combinations thereof.

According to the present invention, said improved and “green” BBQ or oven fire starter is advantageous in that it has fast lighting ability in addition to enhancing a pleasant odor.

According to the present invention, the term “green” product refers to a product that is made of natural, non-synthetic materials, such as citrus peels.

According to the present invention, the term “control experiment” refers to a test of lighting a different fire starter that has been purchased in a store or in a supermarket.

According to the present invention, the term “natural resin” refers to a solid or highly viscous substance of a tree or other plants. Natural resins are usually mixtures comprising organic compounds such as terpenes and volatile oils.

According to the present invention, the term Venturi effect refers to the reduction in fluid pressure that results when a fluid flows through a constricted section (or choke) of a pipe

According to the present invention, the term “package” refers to several materials combined together in any shape such as ball shape.

According to the present invention, the term BBQ, or barbecue, refers to cooking method and/or device using fire and smoke to cook foods such as meat.

According to an embodiment of the present invention, there is provided a method of producing said dried mass of citrus peels, comprising the following steps:
collecting peels of citrus fruits;
air-drying the peels and optionally further drying the peels in an oven;
adding an organic wick or thread;
optionally wrapping the peels with paper to form a package; and
covering the peels with a natural resin or wax that has been heated to liquid state.

According to an embodiment of the present invention, there is provided another method of producing said dried mass of citrus peels, comprising the following steps:
collecting peels of citrus fruits;
air-drying the peel and optionally further drying the peels in an oven;
adding an organic wick;
covering the peels with a natural oil, a natural resin or gum and/or an essential oil, aroma chemical or fragrance;
optionally wrapping the peels with paper; and
forming a package in any shape or form or leaving the peels in bulk form.

According to some embodiments of the present invention, the citrus peels are selected from citron, grapefruit, lemon, lime, mandarin, orange, pomelo, sweet or bitter orange and the like and combination of citrus peels thereof.

According to the present invention, the drying temperature of the citrus peels is over 50° C., over 60° C., over 70° C., over 80° C., over 90° C., over 100° C., over 110° C., or over 120° C.

According to some embodiments of the present invention, the paper is selected from cardboard, fine paper, newsprint, packaging paper, packaging paperboard, tissue paper and combinations thereof.

According to some embodiments of the present invention, the wicks or threads are selected from candle wicks, cotton wicks, hemp wicks, wood wicks and the like.

According to some embodiments of the present invention, the natural resins are selected from Amber, Balm of Gilead, Balsam, Boswellia, Colophonium, Copal, Dammar Gum, Elemi, Galbanum, Gum Guaiacum, Kauri Gum, Labdanum, Mastic, Myrrh, Olibanum, Pine Resin, Sandarac Resin, Styrax and combinations thereof.

According to some embodiments of the present invention, the wax is selected from Bayberry wax, Beeswax, Candelilla, Carnauba palm, Castor wax, Ceresin wax, Chinese wax, Esparto wax, Japanese wax, Jojoba oil, Lanolin, Microcrystalline wax, Montan wax, Quricury wax, Ozocerite, Paraffin wax, Rice bran wax, Shellac, Soy wax, Tallow tree wax and combinations thereof.

Table 2 below includes data on the photographs of the fire starter of the present invention depicting the process of lighting charcoal or wood in outdoor grills and in fireplaces using the fire starters of the present invention. Table 2 also includes data on pictures depicting different kinds of said fire starter.

TABLE 2

| FIG. No | Description |
|---|---|
| 1 | Lemon peels to which a cotton wick is attached, |
| | dipped in lavender oil and covered with pine oil |
| 2 | Lighting the fire in the BBQ with the lemon peels |
| | to which a cotton wick is attached, dipped in |
| | lavender oil and covered with pine oil |
| 3 | Citrus peels wrapped with colored paper before |
| | dipping in liquid resin |
| 4 | Citrus peels wrapped with white paper or printed |
| | paper before dipping in liquid resin |
| 5 | Lemon peels wrapped with white paper, dipped in |
| | a resin and with a connected thread |
| 6 | Fire starter “candies” |
| 7 | Wood lighted in the stove with the fire starter |
| 8 | An outside look of the fire started in the fireplace |
| 9 | Citrus peels wrapped with paper |
| 10 | Lighting the charcoal with the fire starter in |
| | the BBQ device |
| 11 | Meat on the BBQ (Example 5) |
| 12 | Fire starter in the fireplace wrapped with paper |
| | and covered with resin |

### EXAMPLES

### Example 1

This example details the use of “green” BBQ or oven starter comprising dried mass of lemon peels.

The dried mass of lemon peels, weighing about 20 g, equipped with a cotton wick, dipped in lavender oil and covered with pine oil, was placed on an outdoor grill containing about 1 kg of charcoal chunks having the size of about 3-5 cm×3-5 cm. The charcoal chunks were lighted instantly and burned steadily within 30 seconds.

### Example 2

This example details the use of “green” BBQ or oven starter comprising dried mass of orange peels.

The dried mass of orange peels, weighing about 25 g, equipped with a cotton wick, dipped in rosemary oil and covered with pine oil, was placed on an outdoor grill containing about 1 kg of charcoal chunks having the size of about 3-5 cm×3-5 cm. The charcoal chunks were lighted and burned steadily within 1 minute.

### Example 3

This example details the use of “green” BBQ or oven fire starter composed of lemon peels covered with pine resin to which a thin wick was connected.

The fire starter was lighted and caught fire within 2 minutes and burned efficiently. The charcoal caught fire within 3 minutes. Another unit was added, which caused the near charcoal chunks to catch fire within 2 minutes and the following burning was very efficient. Meat was put on the BBQ within about 30 minutes after starting.

### Example 4

This example details the use of “green” BBQ or oven fire starter composed of dried lemon peels covered with pine resin to which a wick was connected for burning wood.

In order to assist the system to catch fire, some small pieces of wood and paper were added. The fire starter was lighted and caught fire within 30 seconds and burned efficiently after which time wood started to burn very efficiently and 1 minute later the wood was vigorously burning.

### Example 5

This example details the use of “green” BBQ or oven fire starter composed of dried mass of lemon peels covered with pine resin and wrapped with paper to which a thick wick was connected.

About 1 Kg of charcoal was placed on the outdoor grill, the fire starter was lighted and caught fire instantly. Another fire starter composed of dried lemon peels covered with eucalyptus oil and wrapped with paper to which a thick wick was connected was added and burned efficiently. Complete burning of the charcoal was achieved within 15 minutes. 5 minutes later sausages were barbequed, which were ready to eat within 10 minutes without any aftertaste or any unpleasant odor of flavor from the BBQ charcoal. Then, some chicken breasts were barbequed, which were ready to eat after few minutes also without any aftertaste or any unpleasant odor or flavor from the BBQ charcoal.

### Example 6

This example details the use of “green” BBQ or oven fire starter composed of dried citrus peels wrapped with paper and covered with pine resin and with no added wick or thread.

About 1 Kg of charcoal was placed on the outdoor grill. The fire starter was lighted and caught fire within 2 minutes and burned efficiently spreading pleasant odor. Adequate burning of the charcoal was achieved within 7 minutes.

### Example 7

This example details the use of “green” BBQ or oven fire starter composed of dried citrus peels covered with pine resin but without wrapping of paper or connecting a wick or thread.

About 1 Kg of charcoal was placed on the outdoor grill. The fire starter was lighted and caught fire instantly and burned efficiently spreading pleasant odor. Adequate burning of the charcoal was achieved within 12 minutes.

### Example 8

This example details the use of “green” BBQ or oven fire starter composed of dried citrus peels covered with pine resin, myrrh and olibanum, wrapped with paper to which a wick was attached.

About 1 Kg of charcoal was placed on the outdoor grill. The fire starter was lighted and caught fire instantly and burned efficiently spreading pleasant odor.

### Example 9

This example details the use of “green” BBQ or oven fire starter composed of dried citrus peels covered with wax to which a wick was attached.

About 1 Kg of charcoal was placed on the outdoor grill. The fire starter was lighted and caught fire instantly and efficient burning of the charcoal was achieved within 11 minutes.

### Example 10

This example details the use of “green” BBQ or oven fire starter composed of dried citrus peels covered with pine resin and wrapped with paper to which a wick was attached.

About 400 g of charcoal were placed on the outdoor grill and the fire starter was lighted and caught fire instantly and burned efficiently spreading pleasant lemon odor. Burning of the charcoal was achieved within 7 minutes.

### Example 11

This example details the use of “green” BBQ or oven fire starter composed of dried citrus peels covered with pine resin and wrapped with paper to which no wick was attached.

About 400 g of charcoal were placed on the BBQ and the fire starter was lighted and caught fire within 4 minutes and burned efficiently spreading pleasant lemon odor. Burning of the charcoal was achieved within 7 minutes and after further 10 minutes the charcoal was burning intensively.

### Example 12

This example details the use of “green” BBQ or oven fire starter composed of dried citrus peels covered with pine resin and wrapped with paper to which no wick or thread was attached.

About 400 g of charcoal were placed on the outdoor grill and the fire starter was lighted and caught fire within 1 minute. The fire starter burned efficiently causing the charcoal to catch fire instantly.

### Example 13

This example details the use of “green” BBQ or oven starter composed of dried citrus peels covered with pine resin and wrapped with paper to which a wick was attached.

About 400 g of charcoal were placed on the outdoor grill and the fire starter was lighted and caught fire within 1 minute. The fire starter burned efficiently causing the charcoal to catch fire instantly.

### Example 14

This example details the use of “green” BBQ or oven fire starter composed of dried citrus peels covered with wax and wrapped with paper to which a thick thread was attached.

About 400 g of charcoal were placed on the outdoor grill and the fire starter was lighted and caught fire within 1 minute. The fire starter burned efficiently causing the charcoal to catch fire instantly.

### Example 15

This example details the use of “green” BBQ or oven starter composed of dried citrus peels covered with wax, pine resin and wrapped with paper to which a thread was attached.

About 500 g of charcoal were placed on the outdoor grill and the fire starter was lighted and caught fire within 1 minute. The fire starter burned efficiently, causing the charcoal to catch fire instantly. Intensive burning of the charcoal was achieved within 2 minutes.

### Example 16

This example details the use of “green” BBQ or oven fire starter composed of dried citrus peels covered with wax on a layer of pine resin and wrapped with paper. A thread was attached to the fire starter.

About 500 g of charcoal were placed on the outdoor grill and the fire starter was lighted and caught fire within a minute and burned efficiently causing the charcoal to catch fire instantly. Intensive burning of the charcoal was achieved within 2 minutes.

### Example 17

This example details the use of “green” BBQ or oven starter composed of dried citrus peels covered with pine resin, myrrh and olibanum and wrapped with paper to which a wick was attached.

About 500 g of charcoal were placed on the outdoor grill and the fire starter was lighted and caught fire instantly. It burned efficiently, spreading a pleasant odor, causing the charcoal to catch fire instantly. Intensive burning of the charcoal was achieved within 2 minutes.

### Example 18

This example details the use of “green” BBQ or oven starter composed of dried citrus peels wrapped with paper, pine resin, myrrh and olibanum to which a wick was attached.

About 1 kg of wood was placed in a closed steel fireplace. The fire starter was lighted and caught fire instantly and burned efficiently causing the wood to catch fire instantly. Intensive burning of the wood was achieved within 30 seconds.

### Example 19

This example details the use of commercial fire starter so called “Match Head”.

About 800 g of charcoal were placed on the outdoor grill and a fire starter so called “Match Head” was used to light the charcoal. The charcoal was lighted almost instantly but a lot of black smoke was emitted along with a disagreeable odor. 5 minutes after lighting the charcoal the flame was extinguished spontaneously.

### Example 20

This example details the use of commercial fire starter in the form of briquettes containing potassium chlorate.

About 800 g of charcoal were placed on the outdoor grill and a fire starter briquette containing potassium chlorate, which is toxic by inhalation or swallowing, was used to light the charcoal. The charcoal was lighted almost instantly but 4 minutes after lighting the charcoal, the flame was extinguished spontaneously.

### Example 21

This example details the use of commercial fire starter in the form of white gel, which contains, according to its label, hydrocarbons.

About 800 g of charcoal were placed on the outdoor grill and a fire starter in the form of white gel, which contains, according to its label, hydrocarbons was used to light the charcoal. The white gel was not easy to handle because of its tendency to break easily and to crumble. The charcoal was lighted almost instantly emitting a lot of white smoke along with discharging an unpleasant odor.

### Example 22

This example details the use of commercial fire starter in the form of compressed sawdust.

About 800 g of charcoal were placed on the outdoor grill and a fire starter comprising compressed sawdust was used to light the charcoal. The compressed sawdust lighted almost instantly and the charcoal caught fire within 5 minutes but an unpleasant odor was liberated.

### Example 23

This example details the use of commercial fire starter composed of a hydrocarbon solvent (kerosine).

About 800 g of charcoal were placed on the outdoor grill and about 2-3 ml of a fire starter comprising heavy hydrogenated petroleum solvent (kerosine) was used to light the charcoal. The liquid was lighted almost instantly and the charcoal caught fire swiftly but the flame was extinguished spontaneously after 2 minutes. Process was repeated with larger volume of solvent but the flame was extinguished spontaneously also in this case.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An improved and “green” BBQ, fireplace or oven fire starter comprising a dried mass of citrus peels to which an organic wick or thread is connected, dipped in an essential oil, aroma chemical or fragrance and/or covered with a natural oil, natural resin or gum and optionally wrapped with paper.

2. The improved and “green” BBQ, fireplace or oven fire starter of claim 1, which enables fast and efficient lightning of BBQ charcoal or wood.

3. The improved and “green” BBQ, fireplace or oven fire starter of claim 1, wherein the citrus peels are selected from citron, grapefruit, lemon, lime, mandarin, orange, pomelo, sweet or bitter orange and combination of citrus peels thereof.

4. The improved and “green” BBQ, fireplace or oven fire starter of claim 1, wherein the essential oils, aroma chemicals or fragrances are selected from Agar oil, Ajwain oil, Angelica root oil, Anise oil, Basil oil, Bay oil, Bergamot oil, Black pepper oil, Birch oil, Camphor oil, Caraway seed oil, Cardamom seed oil, Carrot seed oil, Carvacrol, Cedar oil, Chamomile oil, Cinnamon oil, Citron oil, Citronella oil, Clove oil, Coconut oil, Coriander oil, Cranberry seed oil, Cumin seed oil, Curry leaf oil, Cypress oil, Cypriol oil, Dill oil, Eucalyptus oil, Fennel seed oil, Garlic oil, Geranium oil, Ginger oil, Grapefruit oil, Henna oil, Horseradish oil, Jasmine oil, Lavender oil, Lemon oil, Lemongrass oil, Lime oil, Linalool, d-Limonene, Mandarin oil, Marjoram oil, Mint oil, Moringa oil, Mustard oil, Myrrh oil, Neem oil, Nutmeg oil, Orange oil, Oregano oil, Parsley oil, Perilla oil, Peppermint oil, Pine oil, Red Cedar oil, Rose oil, Rosemary oil, Rosewood oil, Sage oil, Savory oil, Spearmint oil, Tangerine oil, Tarragon oil, Tea tree oil, Thyme oil, Thymol, Turmeric and combinations thereof.

5. The improved and “green” BBQ, fireplace or oven fire starter of claim 1, wherein the wicks or threads are selected from candle wicks, cotton wicks, hemp wicks, wood wicks and combinations thereof.

6. The improved and “green” BBQ, fireplace or oven fire starter of claim 1, wherein the natural oils, natural resins or gums are selected from Amber, Balm of Gilead, balsam, Boswellia, Colophonium, Copal, Dammar Gum, Elemi, Galbanum, Gum Guaiacum, Kauri Gum, Labdanum, Mastic, Myrrh, Olibanum, Pine Resin, Sandarac Resin, Styrax and combinations thereof.

7. The improved and “green” BBQ, fireplace or oven fire starter of claim 1, wherein said improved and “green” BBQ or oven fire starter is advantageous in that it has fast lighting ability in addition to enhancing a pleasant odor.

8. A method of producing a dried mass of citrus peels used as “green” BBQ, fireplace or oven fire starter, comprising the following steps:
collecting peels of citrus fruits;
air-drying the peel and optionally further drying the peels in an oven;
adding an organic wick or thread;
optionally wrapping the peels with paper to form a package; and
covering the peels with a natural resin or wax that has been heated to liquid state.

9. The method of producing a dried mass of citrus peels used as “green” BBQ, fireplace or oven fire starter of claim 8, wherein the citrus peels are selected from citron, grapefruit, lemon, lime, mandarin, orange, pomelo, sweet or bitter orange and combination of citrus peels thereof.

10. The method of producing a dried mass of citrus peels used as “green” BBQ, fireplace or oven fire starter of claim 8, wherein the drying temperature of the citrus peels is over 50° C., over 60° C., over 70° C., over 80° C., over 90° C., over 100° C., over 110° C., or over 120° C.

11. The method of producing a dried mass of citrus peels used as “green” BBQ, fireplace or oven fire starter of claim 8, wherein the paper is selected from cardboard, fine paper, newsprint, packaging paper, packaging paperboard, tissue paper and combinations thereof.

12. The method of producing a dried mass of citrus peels used as “green” BBQ, fireplace or oven fire starter of claim 8, wherein the natural resins are selected from Amber, Balm of Gilead, balsam, Boswellia, Colophonium, Copal, Dammar Gum, Elemi, Galbanum, Gum Guaiacum, Kauri Gum, Labdanum, Mastic, Myrrh, Olibanum, Pine Resin, Sandarac Resin, Styrax and combinations thereof.

13. The method of producing a dried mass of citrus peels used as “green” BBQ, fireplace or oven fire starter of claim 8, wherein the wax is selected from Bayberry wax, Beeswax, Candelilla, Carnauba palm, Castor wax, Ceresin wax, Chinese wax, Esparto wax, Japanese wax, Jojoba oil, Lanolin, Microcrystalline wax, Montan wax, Quricury wax, Ozocerite, Paraffin wax, Rice bran wax, Shellac, Soy wax, Tallow tree wax and combinations thereof.

14. A method of producing a dried mass of citrus peels used as “green” BBQ, fireplace or oven fire starter, comprising the following steps:
collecting peels of citrus fruits;
air-drying the peel and optionally further drying the peels in an oven;
adding an organic wick;
covering the peels with a natural oil, a natural resin or gum and/or an essential oil, aroma chemical or fragrance;
optionally wrapping the peels with paper; and
forming a package in a shape or form or leaving the peels in bulk.

15. The method of producing a dried mass of citrus peels used as “green” BBQ, fireplace or oven fire starter of claim 14, wherein the citrus peels are selected from citron, grapefruit, lemon, lime, mandarin, orange, pomelo, sweet or bitter orange and combination of citrus peels thereof.

16. The method of producing a dried mass of citrus peels used as “green” BBQ, fireplace or oven fire starter of claim 14, wherein the drying temperature of the citrus peels is over 50° C., over 60° C., over 70° C., over 80° C., over 90° C., over 100° C., over 110° C., or over 120° C.

17. The method of producing a dried mass of citrus peels used as “green” BBQ, fireplace or oven fire starter of claim 14, wherein the paper is selected from cardboard, fine paper, newsprint, packaging paper, packaging paperboard, tissue paper and combinations thereof.

18. The method of producing a dried mass of citrus peels used as “green” BBQ, fireplace or oven fire starter of claim 14, wherein the natural resins are selected from Amber, Balm of Gilead, balsam, Boswellia, Colophonium, Copal, Dammar Gum, Elemi, Galbanum, Gum Guaiacum, Kauri Gum, Labdanum, Mastic, Myrrh, Olibanum, Pine Resin, Sandarac Resin, Styrax and combinations thereof.

19. The method of producing a dried mass of citrus peels used as “green” BBQ, fireplace or oven fire starter of claim 14, wherein the wax is selected from Bayberry wax, Beeswax, Candelilla, Carnauba palm, Castor wax, Ceresin wax, Chinese wax, Esparto wax, Japanese wax, Jojoba oil, Lanolin, Microcrystalline wax, Montan wax, Quricury wax, Ozocerite, Paraffin wax, Rice bran wax, Shellac, Soy wax, Tallow tree wax and combinations thereof.
